(19) United States
(12) Patent Application Publication
(10) Pub. No.: US 2022/0380224 A1
(43) Pub. Date: Dec. 1, 2022

(54) AMMONIA DERIVATIVE PRODUCTION PLANT AND AMMONIA DERIVATIVE PRODUCTION METHOD

(71) Applicant: MITSUBISHI HEAVY INDUSTRIES, LTD., Tokyo (JP)

(72) Inventors: Tatsuya TSUJIUCHI, Tokyo (JP); Takuya HIRATA, Tokyo (JP); Shinya TACHIBANA, Yokohama-shi (JP); Takahito YONEKAWA, Yokohama-shi (JP)

(21) Appl. No.: 17/773,770

(22) PCT Filed: Dec. 21, 2020
(86) PCT No.: PCT/JP2020/047616

§ 371 Date: May 2, 2022

(30) Foreign Application Priority Data
Dec. 25, 2019 (JP) 2019-233987

(51) Int. Cl. C01C 1/04

(52) U.S. Cl. CPC C01C 1/04

(57) ABSTRACT

An ammonia derivative production plant includes: an electrolyzer for electrolyzing water; an ammonia synthesis system for synthesizing ammonia from hydrogen produced by the electrolyzer and nitrogen; a carbon dioxide generation system for producing carbon dioxide; and an ammonia derivative synthesis system for synthesizing an ammonia derivative from ammonia synthesized by the ammonia synthesis system and carbon dioxide produced by the carbon dioxide generation system. Oxygen produced by the electrolyzer is consumed to produce carbon dioxide by the carbon dioxide generation system.

### TECHNICAL FIELD

The present disclosure relates to an ammonia derivative production plant and an ammonia derivative production method.

### BACKGROUND

In a conventional ammonia production plant, syngas is produced from fossil fuels such as natural gas and coal, and hydrogen in the syngas reacts with nitrogen in the atmosphere in the Haber Bosch process to synthesize ammonia (for example, Patent Document 1). Further, ammonia derivatives such as urea and melamine can be synthesized using the synthesized ammonia as a raw material.

However, in such a conventional ammonia production plant, the use of fossil fuels produces carbon dioxide as a by-product, so that carbon dioxide emissions, which may lead to global warming, are problematic. To solve this problem, Patent Document 2 describes that hydrogen produced by electrolyzing water is reacted with nitrogen in the atmosphere to synthesize ammonia. According to this technique, hydrogen can be obtained without producing carbon dioxide derived from fossil fuels.

### CITATION LIST

### Patent Literature

Patent Document 1: US Patent Application Publication No. 2015/0183650
Patent Document 2: WO2017/104021A

### SUMMARY

### Problems to be Solved

However, the method described in Patent Document 2 also produces oxygen by electrolysis of water, and if the produced oxygen is not used effectively, it leads to an ineffective production cost.

In view of the above, an object of at least one embodiment of the present disclosure is to provide an ammonia derivative production plant and an ammonia derivative production method with reduced production cost of ammonia derivative.

### Solution to the Problems

To achieve the above object, an ammonia derivative production plant according to the present disclosure includes: an electrolyzer for electrolyzing water; an ammonia synthesis system for synthesizing ammonia from hydrogen produced by the electrolyzer and nitrogen; a carbon dioxide generation system for producing carbon dioxide; and an ammonia derivative synthesis system for synthesizing an ammonia derivative from ammonia synthesized by the ammonia synthesis system and carbon dioxide produced by the carbon dioxide generation system. Oxygen produced by the electrolyzer is consumed to produce carbon dioxide by the carbon dioxide generation system.

Further, an ammonia derivative production method according to the present disclosure includes: an electrolysis step of electrolyzing water; an ammonia synthesis step of synthesizing ammonia from hydrogen produced in the electrolysis step and nitrogen; a carbon dioxide generation step of producing carbon dioxide; and an ammonia derivative synthesis step of synthesizing an ammonia derivative from ammonia synthesized in the ammonia synthesis step and carbon dioxide produced in the carbon dioxide generation step. Oxygen produced in the electrolysis step is consumed to produce carbon dioxide in the carbon dioxide generation step.

### Advantageous Effects

According to an ammonia derivative production plant and an ammonia derivative production method of the present disclosure, since oxygen produced by the electrolyzer is consumed to produce carbon dioxide by the carbon dioxide generation system, the production cost of ammonia derivative can be reduced.

### BRIEF DESCRIPTION OF DRAWINGS

FIG. 1 is a configuration diagram of an ammonia derivative production plant according to the first embodiment of the present disclosure.

FIG. 2 is a configuration diagram of an ammonia derivative production plant according to the second embodiment of the present disclosure.

FIG. 3 is a configuration diagram of an ammonia derivative production plant according to the third embodiment of the present disclosure.

FIG. 4 is a configuration diagram of an ammonia derivative production plant according to the fourth embodiment of the present disclosure.

FIG. 5 is a configuration diagram of an ammonia derivative production plant according to the fifth embodiment of the present disclosure.

### DETAILED DESCRIPTION

Hereinafter, an ammonia derivative production plant and an ammonia derivative production method according to embodiments of the present disclosure will be described with reference to the drawings. The following embodiments are illustrative and not intended to limit the present disclosure, and various modifications are possible within the scope of technical ideas of the present disclosure.

### First Embodiment

### <Configuration of Ammonia Derivative Production Plant According to First Embodiment>

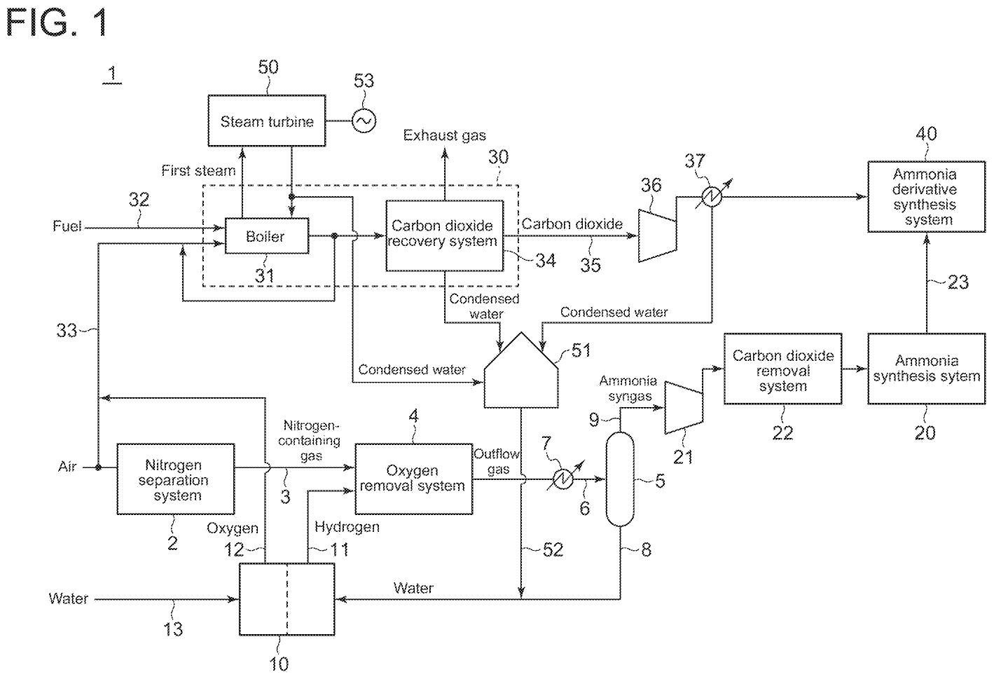

As shown in FIG. 1, an ammonia derivative production plant 1 according to the first embodiment of the present disclosure includes an electrolyzer 10 for electrolyzing water to produce hydrogen and oxygen, an ammonia synthesis system 20 for synthesizing ammonia from hydrogen produced by the electrolyzer 10 and nitrogen, a carbon dioxide generation system 30 for producing carbon dioxide, and an ammonia derivative synthesis system 40 for synthesizing an ammonia derivative from ammonia synthesized by the ammonia synthesis system 20 and carbon dioxide produced by the carbon dioxide generation system 30. Here, the ammonia derivative may be, but is not limited to, urea, melamine, or melamine resin.

The source of nitrogen used in the ammonia synthesis system 20 is not limited but may be nitrogen stored in a vessel or nitrogen supplied from another plant, for example. When nitrogen in the atmosphere is used, the ammonia derivative production plant 1 may be provided with a nitrogen separation system 2 for separating nitrogen from the air. The configuration of the nitrogen separation system 2 is not limited but may be a PSA (pressure swing adsorption) nitrogen gas generation device, a device with the low temperature separation process, or a device with the membrane separation process, for example.

The nitrogen separation system 2 is connected to a nitrogen-containing gas flow pipe 3 for flowing, out of the nitrogen separation system 2, a nitrogen-containing gas which contains nitrogen separated from the air. In the nitrogen-containing gas, oxygen in the air remains. If the nitrogen-containing gas in which oxygen remains is supplied to the ammonia synthesis system 20, the performance of an ammonia synthesis catalyst for synthesizing ammonia from nitrogen and hydrogen in the ammonia synthesis system 20 is deteriorated. Thus, in order to remove oxygen remaining in the nitrogen-containing gas, an oxygen removal system 4 may be provided in the ammonia derivative production plant 1. By removing oxygen in the nitrogen-containing gas by the oxygen removal system 4, the deterioration in performance of the ammonia synthesis catalyst can be suppressed.

As the oxygen removal system 4, for example, a device configured to react hydrogen produced by the electrolysis of water supplied to the electrolyzer 10 through a water supply pipe 13 with oxygen in the nitrogen-containing gas may be used. In this case, the oxygen removal system 4 needs to be connected to the nitrogen-containing gas flow pipe 3 and a hydrogen flow pipe 11 for flowing hydrogen out of the electrolyzer 10. With this configuration, the nitrogen-containing gas and hydrogen can be supplied to the oxygen removal system 4.

When the oxygen removal system 4 is configured to react hydrogen with oxygen in the nitrogen-containing gas, an outflow gas from the oxygen removal system 4 contains water in addition to nitrogen and hydrogen. Therefore, in order to remove water from the outflow gas, a gas-liquid separation device 5 may be provided in the ammonia derivative production plant 1. In this case, the gas-liquid separation device 5 is configured to communicate with the oxygen removal system 4 through an outflow gas flow pipe 6, and the outflow gas flow pipe 6 is equipped with a cooler 7 for cooling the outflow gas to liquefy water in the outflow gas.

The gas-liquid separation device 5 and the electrolyzer 10 may be connected via a water recycling pipe 8 to use water separated by the gas-liquid separation device 5 as part of water electrolyzed by the electrolyzer 10. With this configuration, since water produced by the reaction between oxygen and hydrogen in the oxygen removal system 4 is used as part of water electrolyzed by the electrolyzer 10, the consumption of water in the electrolyzer 10 is reduced. As a result, the cost of producing an ammonia derivative in the operation described later can be reduced.

In order to supply the gas from which water is separated by the gas-liquid separation device 5 to the ammonia synthesis system 20 as ammonia synthesizing gas used as a raw material for synthesizing ammonia in the ammonia synthesis system 20, the gas-liquid separation device 5 communicates with the ammonia synthesis system 20 through an ammonia synthesizing gas supply pipe 9. The ammonia synthesizing gas supply pipe 9 may be provided with an ammonia synthesizing gas compressor 21 for supplying the ammonia synthesizing gas to the ammonia synthesis system 20 and a carbon dioxide removal system 22 for removing carbon dioxide contained in the ammonia synthesizing gas. The configuration of the carbon dioxide removal system 22 is not limited but may be, for example, a device designed to remove carbon dioxide by methanation, or a facility which includes a device designed to bring an absorption solvent and the ammonia synthesizing gas into gas-liquid contact to absorb carbon dioxide by the absorption solvent and a device designed to recover carbon dioxide from the absorption solvent.

The configuration of the carbon dioxide generation system 30 is not limited and may include a boiler 31, for example. When the carbon dioxide generation system 30 includes the boiler 31, a fuel supply pipe 32 and an air supply pipe 33 are connected to the boiler 31 to supply fuel and air to the boiler 31. To the electrolyzer 10, one end of an oxygen flow pipe 12 for discharging oxygen produced by the electrolyzer 10 is connected. The other end of the oxygen flow pipe 12 is connected to the air supply pipe 33. In the boiler 31, steam (first steam) is produced by combustion heat generated when the fuel is combusted. A steam turbine 50 using this steam as the driving steam and a generator 53 for generating electricity by power from the steam turbine 50 may be provided in the ammonia derivative production plant 1.

When the carbon dioxide generation system 30 includes the boiler 31, exhaust gas generated by the combustion of fuel in the boiler 31 contains carbon dioxide. The carbon dioxide generation system 30 thus needs a carbon dioxide recovery system 34 for recovering carbon dioxide from the exhaust gas of the boiler 31. The configuration of the carbon dioxide recovery system 34 is not limited but may be, for example, a facility which includes a device designed to bring an absorption solvent and the exhaust gas into gas-liquid contact to absorb carbon dioxide by the absorption solvent and a device designed to recover carbon dioxide from the absorption solvent.

The ammonia derivative synthesis system 40 communicates with the carbon dioxide generation system 30 and the ammonia synthesis system 20 through a carbon dioxide supply pipe 35 and an ammonia supply pipe 23. The carbon dioxide supply pipe 35 may be provided with a carbon dioxide compressor 36 for supplying carbon dioxide to the ammonia derivative synthesis system 40 and a cooler 37 for cooling carbon dioxide flowing out of the carbon dioxide compressor 36.

The ammonia derivative production plant 1 may be equipped with a condensed water recovery device 51 for recovering condensed water in the driving steam that drives the steam turbine 50, condensed water from the carbon dioxide recovery system 34, and condensed water from the cooler 37. The condensed water recovery device 51 and the water recycling pipe 8 may be connected via a water flow pipe 52 to use water recovered by the condensed water recovery device 51 as part of water electrolyzed by the electrolyzer 10.

<Operation of Ammonia Derivative Production Plant According to First Embodiment>

Next, the operation of the ammonia derivative production plant (including ammonia derivative production method) according to the first embodiment of the present disclosure will be described. As shown in FIG. 1, water is electrolyzed in the electrolyzer 10 to produce hydrogen and oxygen. The produced hydrogen and oxygen are discharged from the electrolyzer 10 and flow through the hydrogen flow pipe 11 and the oxygen flow pipe 12, respectively. Nitrogen is separated in the nitrogen separation system 2 from the air, and a nitrogen-containing gas which contains the separated nitrogen is discharged from the nitrogen separation system 2 and flows through the nitrogen-containing gas flow pipe 3. The hydrogen flowing through the hydrogen flow pipe 11 and the nitrogen-containing gas flowing through the nitrogen-containing gas flow pipe 3 are each introduced into the oxygen removal system 4. In the oxygen removal system 4, oxygen that remains in the nitrogen-containing gas reacts with hydrogen to produced water, so that oxygen is removed from the nitrogen-containing gas.

The outflow gas from the oxygen removal system 4 contains at least water and carbon dioxide in addition to hydrogen and nitrogen. When the outflow gas is cooled by the cooler 7 when flowing through the outflow gas flow pipe 6, water vapor contained in the outflow gas is condensed into liquid water and flows into the gas-liquid separation device 5. In the gas-liquid separation device 5, the liquid water falls and collects at the bottom, so that water is separated from the outflow gas. The outflow gas from which water is separated is discharged from the gas-liquid separation device 5 by the ammonia synthesizing gas compressor 21, and flows through the ammonia synthesizing gas supply pipe 9 as the ammonia synthesizing gas. When the ammonia synthesizing gas is circulated through the ammonia synthesizing gas supply pipe 9, carbon dioxide is removed by the carbon dioxide removal system 22, and then the synthesizing gas is introduced into the ammonia synthesis system 20. In the ammonia synthesis system 20, hydrogen and nitrogen react to synthesize ammonia. The synthesized ammonia is introduced into the ammonia derivative synthesis system 40 through the ammonia supply pipe 23.

On the other hand, fuel and air are supplied to the boiler 31 through the fuel supply pipe 32 and the air supply pipe 33, respectively. In addition to this, the boiler 31 is supplied with oxygen produced by the electrolyzer 10 after flowing through the oxygen flow pipe 12 and then merging with the air flowing through the air supply pipe 33. In the boiler 31, fuel is combusted, and steam is generated by combustion heat while exhaust gas is generated. The generated steam is used as driving steam for driving the steam turbine 50, and power obtained from the steam turbine 50 is used to generate electricity in the generator 53. Since the boiler 31 is supplied with oxygen produced by the electrolyzer 10 in addition to the air flowing through the air supply pipe 33, oxygen produced by the electrolyzer 10 is consumed to produce carbon dioxide by the carbon dioxide generation system 30 and thus effectively used. Due to the effective use of oxygen, the oxygen concentration in the air supplied to the boiler 31 increases, and the carbon dioxide concentration in the combustion exhaust gas introduced into the carbon dioxide recovery system 34 also increases. Thus, by decreasing the total amount of exhaust gas, it is possible to reduce the size and cost of the carbon dioxide recovery system 34.

The exhaust gas generated in the boiler 31 contains carbon dioxide. Therefore, carbon dioxide is recovered from the exhaust gas by the carbon dioxide recovery system 34. The exhaust gas from which carbon dioxide is removed is released into the atmosphere or supplied to an exhaust gas treatment device (not shown). On the other hand, the recovered carbon dioxide is discharged from the carbon dioxide recovery system 34 by the carbon dioxide compressor 36 and then flows through the carbon dioxide supply pipe 35. The carbon dioxide is cooled by the cooler 37 when flowing through the carbon dioxide supply pipe 35, and is introduced into the ammonia derivative synthesis system 40. In the ammonia derivative synthesis system 40, an ammonia derivative is synthesized from ammonia and carbon dioxide.

During the above operation, condensed water in the driving steam that drives the steam turbine 50, condensed water from the carbon dioxide recovery system 34, and condensed water from the cooler 37 are recovered by the condensed water recovery device 51. The water collected in the gas-liquid separation device 5 is supplied to the electrolyzer 10 through the water recycling pipe 8. The water recovered by the condensed water recovery device 51 flows into the water recycling pipe 8 through the water flow pipe 52, merges with water flowing through the water recycling pipe 8, and is supplied to the electrolyzer 10.

Thus, with the ammonia derivative production plant 1 according to the first embodiment of the present disclosure, since oxygen produced by the electrolyzer 10 is consumed to produce carbon dioxide by the carbon dioxide generation system 30, the production cost of ammonia derivative can be reduced.

### Second Embodiment

Next, an ammonia derivative production plant according to the second embodiment will be described. The ammonia derivative production plant according to the second embodiment is configured to use high-temperature electrolysis for electrolyzing water in contrast to the first embodiment. In the second embodiment, the same constituent elements as those in the first embodiment are associated with the same reference numerals and not described again in detail.

<Configuration of Ammonia Derivative Production Plant According to Second Embodiment>

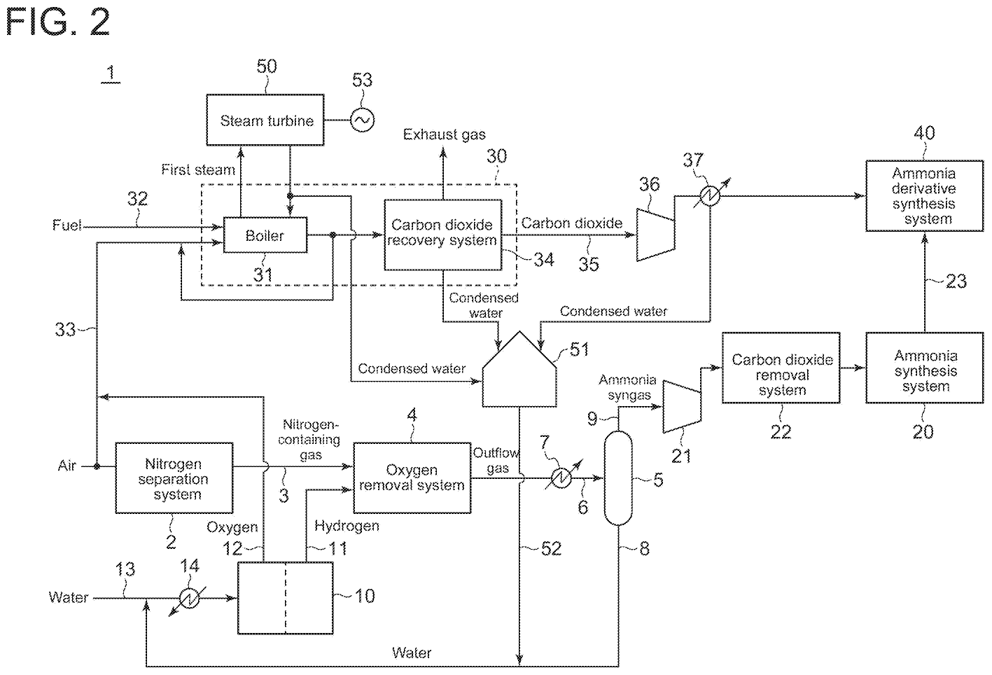

As shown in FIG. 2, the water supply pipe 13 for supplying water to the electrolyzer 10 is provided with a water preheater 14. The water recycling pipe 8 connected at one end to the gas-liquid separation device 5 is connected at the other end to the water supply pipe 13 on the upstream side of the water preheater 14. The configuration of the water preheater 14 is not limited, but may be a configuration in which water is preheated by any form of energy such as electric energy, or may be a heat exchanger configured to exchange heat between a heat medium such as steam and water. When the water preheater 14 is the latter heat exchanger, the heat medium may be steam generated by exhaust heat generated by the synthesis of ammonia in the ammonia synthesis system 20 or steam generated by exhaust heat generated by the reaction between oxygen and hydrogen in the oxygen removal system 4. The configuration is otherwise the same as that of the first embodiment

<Operation of Ammonia Derivative Production Plant According to Second Embodiment>

Next, the operation of the ammonia derivative production plant according to the second embodiment of the present disclosure will be described. As shown in FIG. 2, water is supplied to the electrolyzer 10 through the water supply pipe 13, but water flowing through the water supply pipe 13 is preheated by the water preheater 14 and then is introduced into the electrolyzer 10. As described in the first embodiment, water collected in the gas-liquid separation device 5 and water recovered by the condensed water recovery device 51 are supplied to the electrolyzer 10 through the water recycling pipe 8, but since the water recycling pipe 8 is connected to the water supply pipe 13 on the upstream side of the water preheater 14, water supplied to the electrolyzer 10 through the water recycling pipe 8 is also preheated by the water preheater 14 and then introduced into the electrolyzer 10. The operation is otherwise the same as that of the first embodiment

Thus, since water supplied to the electrolyzer 10 is preheated by exhaust heat generated by the synthesis of ammonia in the ammonia synthesis system 20 or exhaust heat generated by the reaction between oxygen and hydrogen in the oxygen removal system 4, high-temperature steam electrolysis can be used in the electrolyzer 10, so that the efficiency of electrolysis can be improved. As a result, the production cost of ammonia derivative can be reduced.

### Third Embodiment

Next, an ammonia derivative production plant according to the third embodiment will be described. The ammonia derivative production plant according to the third embodiment is configured to operate stably even using electricity generated by renewable energy, in contrast to the first or second embodiment. In the following, the third embodiment will be described in conjunction with a modification of the configuration of the first embodiment, but the third embodiment may be obtained by modifying the configuration of the second embodiment. In the third embodiment, the same constituent elements as those in the first embodiment are associated with the same reference numerals and not described again in detail.

<Configuration of Ammonia Derivative Production Plant According to Third Embodiment>

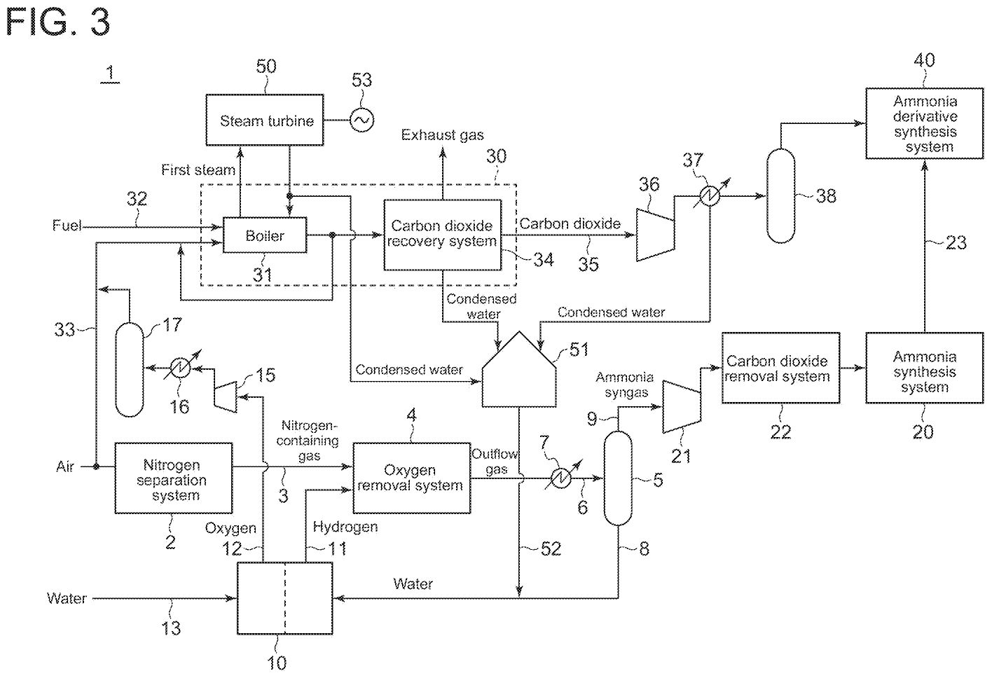

As shown in FIG. 3, the oxygen flow pipe 12 is provided with an oxygen compressor 15, a cooler 16, and an oxygen vessel 17 which is an oxygen storage unit for storing oxygen. The carbon dioxide supply pipe 35 is provided with a carbon dioxide vessel 38, which is a carbon dioxide storage unit for storing carbon dioxide, between the cooler 37 and the ammonia derivative synthesis system 40. The configuration is otherwise the same as that of the first embodiment except that electricity generated by renewable energy is used in the ammonia derivative production plant 1.

<Operation of Ammonia Derivative Production Plant According to Third Embodiment>

Next, the operation of the ammonia derivative production plant according to the third embodiment of the present disclosure will be described. The operation of the third embodiment is the same as that of the first embodiment except that, as shown in FIG. 3, oxygen produced by electrolyzing water in the electrolyzer 10 can be stored in the oxygen vessel 17, and carbon dioxide produced in the carbon dioxide generation system 30 can be stored in the carbon dioxide vessel 38.

In the third embodiment, unlike the first embodiment, electricity generated by renewable energy is used in the ammonia derivative production plant 1. When electricity generated by renewable energy is used in the ammonia derivative production plant 1, the electricity supply may become unstable, and in that case, the production amount and the product quality of ammonia and ammonia derivatives become unstable.

When the amount of electricity generated by renewable energy decreases, in the ammonia derivative production plant 1, electricity is preferentially supplied to the electrolyzer 10, the ammonia synthesis system 20, and the ammonia derivative synthesis system 40, while the carbon dioxide generation system 30 is changed in load or stopped according to the electricity supply capacity. In this case, the consumption amount of oxygen and the production amount of carbon dioxide in the carbon dioxide generation system 30 decrease, so that the amount of oxygen may become excessive, and the amount of carbon dioxide supplied to the ammonia derivative synthesis system 40 may become insufficient.

In contrast, in the third embodiment, at least part of oxygen produced by the electrolyzer 10 can be stored in the oxygen vessel 17, and at least part of carbon dioxide produced by the carbon dioxide generation system 30 can be stored in the carbon dioxide vessel 38. Thus, the problem of excess oxygen can be solved by storing excess oxygen in the oxygen vessel 17 and using the stored oxygen when the power generation is stable. On the other hand, if the production amount of carbon dioxide in the carbon dioxide generation system 30 decreases or becomes zero, by previously storing carbon dioxide in the carbon dioxide vessel 38 when the power generation is stable, the amount of carbon dioxide supplied to the ammonia derivative synthesis system 40 can be secured even when the carbon dioxide generation system 30 is changed in load or stopped. As a result, it is possible to stabilize the production amount and the product quality of ammonia and ammonia derivatives.

### Fourth Embodiment

Next, an ammonia derivative production plant according to the fourth embodiment will be described. The ammonia derivative production plant according to the fourth embodiment is configured to make use of exhaust heat in contrast to the third embodiment. In the fourth embodiment, the same constituent elements as those in the third embodiment are associated with the same reference numerals and not described again in detail.

<Configuration of Ammonia Derivative Production Plant According to Fourth Embodiment>

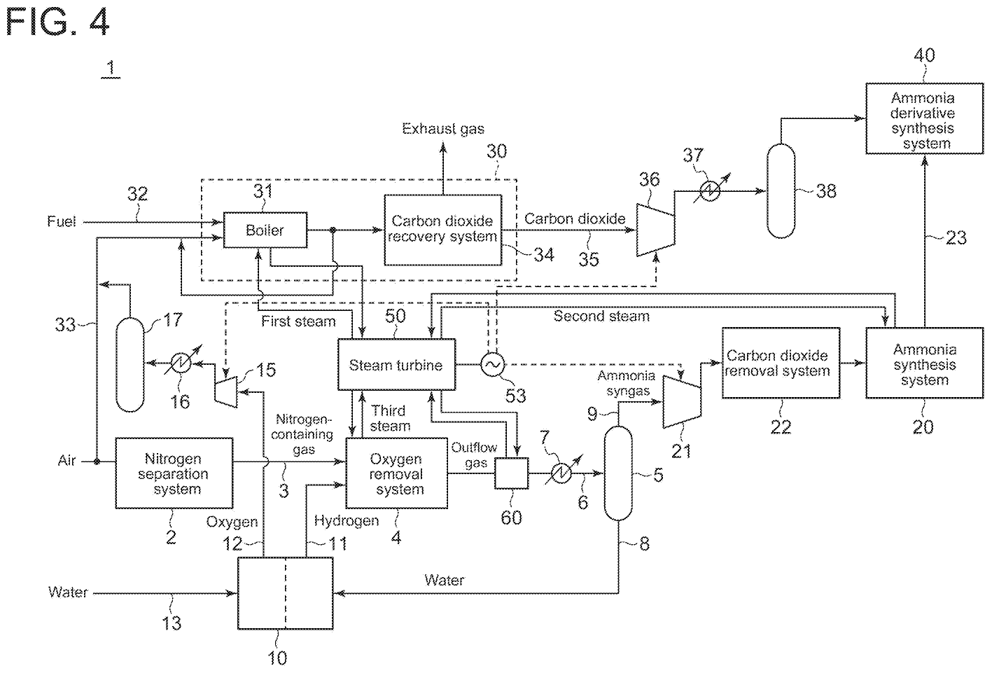

As shown in FIG. 4, the steam turbine 50 is configured to be driven by, in addition to steam (first steam) generated in the boiler 31, both or either of steam (second steam) generated by exhaust heat generated by the synthesis of ammonia in the ammonia synthesis system 20 or steam (third steam) generated by exhaust heat generated by the reaction between oxygen and hydrogen in the oxygen removal system 4. In other words, the driving steam for driving the steam turbine 50 includes the first steam and at least one of the second steam or the third steam.

The third steam may be steam generated by heating water or steam flowing through a flow passage formed in the oxygen removal system 4 with exhaust heat generated by the reaction between oxygen and hydrogen in the oxygen removal system 4, or may be steam generated by exchanging heat with the outflow gas from the oxygen removal system 4 in a heat exchanger 60 provided on the outflow gas flow pipe 6 for recovering heat from the outflow gas, or may be both of them. The configuration is otherwise the same as that of the third embodiment except that the condensed water recovery device 51 (see FIG. 1) is not provided.

<Operation of Ammonia Derivative Production Plant According to Fourth Embodiment>

Next, the operation of the ammonia derivative production plant according to the fourth embodiment of the present disclosure will be described. The operation is the same as that of the third embodiment except that, as shown in FIG. 4, the driving steam for driving the steam turbine 50 includes at least one of the second steam or the third steam in addition to the first steam, and at least one of the oxygen compressor 15, the ammonia synthesizing gas compressor 21, or the carbon dioxide compressor 36 is driven by electricity generated by the generator 53.

In the fourth embodiment, exhaust heat is effectively used by driving the steam turbine 50 with the driving steam including the first steam and at least one of the second steam or the third steam. Thus, it is possible to improve energy efficiency, compared to the third embodiment. Further, in the fourth embodiment, the steam turbine 50 is driven by the driving steam generated by exhaust heat generated in the ammonia derivative production plant 1 to generate electricity, and the electricity is used to drive at least one of the oxygen compressor 15, the ammonia synthesizing gas compressor 21, or the carbon dioxide compressor 36. Thus, it is possible to further improve energy efficiency, compared to the third embodiment.

### Fifth Embodiment

Next, an ammonia derivative production plant according to the fifth embodiment will be described. The ammonia derivative production plant according to the fifth embodiment is configured to make use of exhaust heat in contrast to the third embodiment. In the fifth embodiment, the same constituent elements as those in the third embodiment are associated with the same reference numerals and not described again in detail.

<Configuration of Ammonia Derivative Production Plant According to Fifth Embodiment>

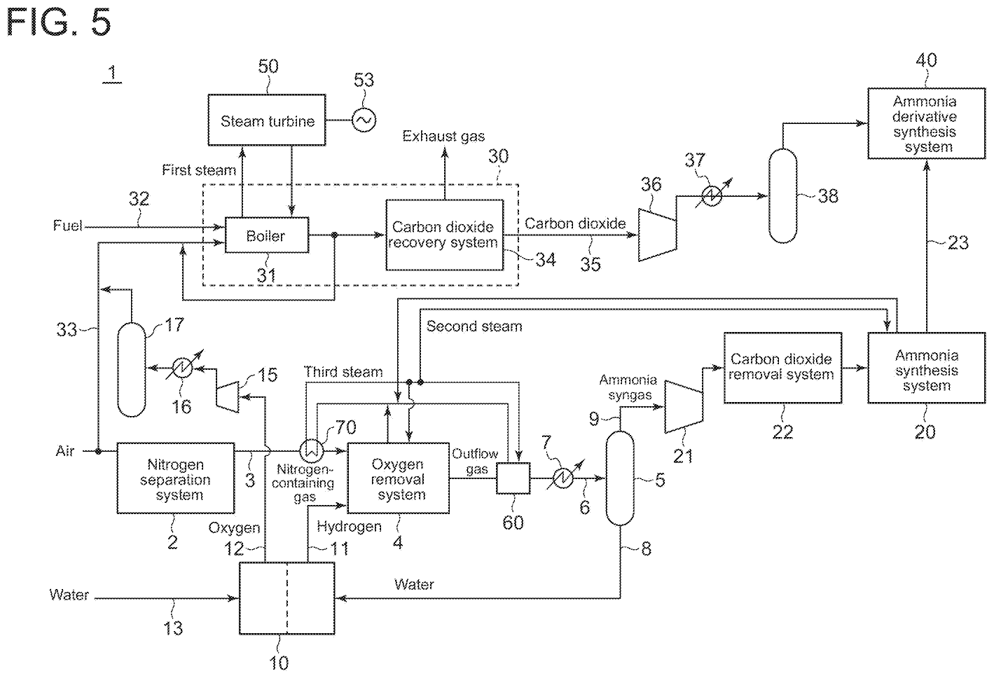

As shown in FIG. 5, the nitrogen-containing gas flow pipe 3 is provided with a nitrogen preheater 70 for preheating the nitrogen-containing gas before flowing into the oxygen removal system 4. In the nitrogen preheater 70, the nitrogen-containing gas exchanges heat with both or either of steam (second steam) generated by exhaust heat generated by the synthesis of ammonia in the ammonia synthesis system 20 or steam (third steam) generated by exhaust heat generated by the reaction between oxygen and hydrogen in the oxygen removal system 4.

The third steam may be steam generated by heating water or steam flowing through a flow passage formed in the oxygen removal system 4 with exhaust heat generated by the reaction between oxygen and hydrogen in the oxygen removal system 4, or may be steam generated by exchanging heat with the outflow gas from the oxygen removal system 4 in a heat exchanger 60 provided on the outflow gas flow pipe 6 for recovering heat from the outflow gas, or may be both of them. The configuration is otherwise the same as that of the third embodiment except that the condensed water recovery device 51 (see FIG. 1) is not provided.

<Operation of Ammonia Derivative Production Plant According to Fifth Embodiment>

Next, the operation of the ammonia derivative production plant according to the fifth embodiment of the present disclosure will be described. The operation is the same as that of the third embodiment except that, as shown in FIG. 5, the nitrogen-containing gas is preheated by the nitrogen preheater 70 before flowing into the oxygen removal system 4.

In the fifth embodiment, the energy required for the oxygen removal system 4 can be reduced by preheating the nitrogen-containing gas before flowing into the oxygen removal system 4 by at least one of the second steam or the third steam. Thus, it is possible to improve energy efficiency by making use of exhaust heat, compared to the third embodiment.

The contents described in the above embodiments would be understood as follows, for instance.

(1) An ammonia derivative production plant according to an aspect includes: an electrolyzer (10) for electrolyzing water; an ammonia synthesis system (20) for synthesizing ammonia from hydrogen produced by the electrolyzer (10) and nitrogen; a carbon dioxide generation system (30) for producing carbon dioxide; and an ammonia derivative synthesis system (40) for synthesizing an ammonia derivative from ammonia synthesized by the ammonia synthesis system (20) and carbon dioxide produced by the carbon dioxide generation system (30). Oxygen produced by the electrolyzer (10) is consumed to produce carbon dioxide by the carbon dioxide generation system (30).

According to the ammonia derivative production plant of the present disclosure, since oxygen produced by the electrolyzer is consumed to produce carbon dioxide by the carbon dioxide generation system, the production cost of ammonia derivative can be reduced.

(2) An ammonia derivative production plant according to another aspect is an ammonia derivative production plant described in (1), further comprising: a nitrogen separation system (2) for separating nitrogen from air; and an oxygen removal system (4) for reacting oxygen that remains in a nitrogen-containing gas containing nitrogen separated by the nitrogen separation system (2) with hydrogen produced by the electrolyzer (10). In the ammonia synthesis system (20), ammonia is synthesized from an outflow gas flowing out of the oxygen removal system (4).

If oxygen remains in the nitrogen-containing gas produced by the nitrogen separation system, oxygen deteriorates the performance of the ammonia synthesis catalyst when ammonia is synthesized from the nitrogen-containing gas and hydrogen in the ammonia synthesis system. However, according to the configuration (2), since oxygen in the nitrogen-containing gas is removed by the reaction between oxygen and hydrogen in the oxygen removal system, the deterioration in performance of the ammonia synthesis catalyst can be suppressed.

(3) An ammonia derivative production plant according to still another aspect is an ammonia derivative production plant described in (2) which is configured to use water produced by the reaction between oxygen and hydrogen in the oxygen removal system (4) as part of water electrolyzed by the electrolyzer (10).

In the configuration (2), water is produced by the reaction between oxygen and hydrogen in the oxygen removal system. According to the configuration (3), since this water is used as part of water electrolyzed by the electrolyzer, the consumption of water in the electrolyzer is reduced. As a result, the production cost of ammonia derivative can be reduced.

(4) An ammonia derivative production plant according to still another aspect is an ammonia derivative production plant described in any one of (1) to (3), further comprising a water preheater (14) for preheating water to be supplied to the electrolyzer (10). The water preheater (14) is configured to preheat water by exhaust heat generated by the synthesis of ammonia in the ammonia synthesis system (20).

According to this configuration, since water supplied to the electrolyzer is preheated by exhaust heat generated by the synthesis of ammonia in the ammonia synthesis system, high-temperature steam electrolysis can be used in the electrolyzer, so that the efficiency of electrolysis can be improved. As a result, the production cost of ammonia derivative can be reduced.

(5) An ammonia derivative production plant according to still another aspect is an ammonia derivative production plant described in (2) or (3), further comprising a water preheater (14) for preheating water to be supplied to the electrolyzer. The water preheater (14) is configured to preheat water by exhaust heat generated by the reaction between oxygen and hydrogen in the oxygen removal system (4).

According to this configuration, since water supplied to the electrolyzer is preheated by exhaust heat generated by the reaction between oxygen and hydrogen in the oxygen removal system, high-temperature steam electrolysis can be used in the electrolyzer, so that the efficiency of electrolysis can be improved. As a result, the production cost of ammonia derivative can be reduced.

(6) An ammonia derivative production plant according to still another aspect is an ammonia derivative production plant described in any one of (1) to (5), further comprising: an oxygen storage unit (oxygen vessel 17) for storing oxygen produced by the electrolyzer (10); and a carbon dioxide storage unit (carbon dioxide vessel 38) for storing carbon dioxide produced by the carbon dioxide generation system (30).

When electricity generated by renewable energy is used in the ammonia derivative production plant described in any one of (1) to (5), the electricity supply may become unstable, and in that case, the production amount and the product quality of ammonia and ammonia derivatives become unstable. In contrast, according to the above configuration (6), oxygen produced by the electrolyzer can be stored in the oxygen storage unit, and carbon dioxide produced by the carbon dioxide generation system can be stored in the carbon dioxide storage unit. Thus, even when electricity is preferentially supplied to the electrolyzer, the ammonia synthesis system, and the ammonia derivative synthesis system while the carbon dioxide generation system is changed in load or stopped according to the electricity supply capacity due to unstable electricity supply, by storing oxygen produced by the electrolyzer in the oxygen storage unit and supplying carbon dioxide stored in the carbon dioxide storage unit to the ammonia derivative synthesis system, it is possible to stabilize the production amount and the product quality of ammonia and ammonia derivatives.

(7) An ammonia derivative production plant according to still another aspect is an ammonia derivative production plant described in (6) in which the carbon dioxide generation system (30) includes a boiler (31) for generating a first steam by combusting a fuel. The ammonia derivative production plant (1) further comprises a steam turbine (50). A driving steam for driving the steam turbine (50) includes: the first steam; and a second steam generated by exhaust heat generated by the synthesis of ammonia in the ammonia synthesis system (20).

According to this configuration, exhaust heat is effectively used by driving the steam turbine with the driving steam including the first steam and the second steam generated by exhaust heat in the ammonia derivative production plant. Thus, it is possible to improve energy efficiency.

(8) An ammonia derivative production plant according to still another aspect is an ammonia derivative production plant described in (6) in which the carbon dioxide generation system (30) includes a boiler (31) for generating a first steam by combusting a fuel. The ammonia derivative production plant (1) further comprises: a steam turbine (50); a nitrogen separation system (2) for separating nitrogen from air; and an oxygen removal system (4) for reacting oxygen that remains in a nitrogen-containing gas containing nitrogen separated by the nitrogen separation system (2) with hydrogen produced by the electrolyzer (10). A driving steam for driving the steam turbine (50) includes: the first steam; and a third steam generated by exhaust heat generated by the reaction between oxygen and hydrogen in the oxygen removal system (4).

According to this configuration, exhaust heat is effectively used by driving the steam turbine with the driving steam including the first steam and the third steam generated by exhaust heat in the ammonia derivative production plant. Thus, it is possible to improve energy efficiency.

(9) An ammonia derivative production plant according to still another aspect is an ammonia derivative production plant described in (8), further comprising a heat exchanger (60) for recovering heat from an outflow gas flowing out of the oxygen removal system (4). The third steam includes steam generated by heat exchange with the outflow gas in the heat exchanger (60).

According to this configuration, exhaust heat is effectively used by driving the steam turbine with the driving steam including the first steam and the third steam generated by exhaust heat in the ammonia derivative production plant. Thus, it is possible to improve energy efficiency.

(10) An ammonia derivative production plant according to still another aspect is an ammonia derivative production plant described in any one of (7) to (9), further comprising: an oxygen compressor (15) for supplying oxygen produced by the electrolyzer to the carbon dioxide generation system (30); and an ammonia synthesizing gas compressor (21) for supplying nitrogen and hydrogen to the ammonia synthesis system (20). The oxygen compressor (15) and the ammonia synthesizing gas compressor (21) are driven by electric power generated by the steam turbine (50).

According to this configuration, the steam turbine is driven by the driving steam generated by exhaust heat generated in the ammonia derivative production plant to generate electricity, and the electricity is used to drive each compressor in the ammonia derivative production plant. Thus, it is possible to further improve energy efficiency.

(11) An ammonia derivative production plant according to still another aspect is an ammonia derivative production plant described in (6), further comprising: a nitrogen separation system (2) for separating nitrogen from air; and an oxygen removal system (4) for reacting oxygen that remains in a nitrogen-containing gas containing nitrogen separated by the nitrogen separation system (2) with hydrogen produced by the electrolyzer (10); and a nitrogen preheater (70) for preheating the nitrogen-containing gas before flowing into the oxygen removal system (4). The nitrogen-containing gas exchanges heat in the nitrogen preheater (70) with a second steam generated by exhaust heat generated by the synthesis of ammonia in the ammonia synthesis system (20).

According to this configuration, the energy required for the oxygen removal system can be reduced by preheating the nitrogen-containing gas with the second steam generated by exhaust heat generated by the synthesis of ammonia in the ammonia synthesis system. Thus, it is possible to improve energy efficiency by making use of exhaust heat.

(12) An ammonia derivative production plant according to still another aspect is an ammonia derivative production plant described in (6), further comprising: a nitrogen separation system (2) for separating nitrogen from air; and an oxygen removal system (4) for reacting oxygen that remains in a nitrogen-containing gas containing nitrogen separated by the nitrogen separation system (2) with hydrogen produced by the electrolyzer (10); and a nitrogen preheater (70) for preheating the nitrogen-containing gas before flowing into the oxygen removal system (4). The nitrogen-containing gas exchanges heat in the nitrogen preheater (70) with a third steam generated by exhaust heat generated by the reaction between oxygen and hydrogen in the oxygen removal system (4).

According to this configuration, the energy required for the oxygen removal system can be reduced by preheating the nitrogen-containing gas with the third steam generated by exhaust heat generated by the reaction between oxygen and hydrogen in the oxygen removal system. Thus, it is possible to improve energy efficiency by making use of exhaust heat.

(13) An ammonia derivative production plant according to still another aspect is an ammonia derivative production plant described in (12), further comprising a heat exchanger (60) for recovering heat from an outflow gas flowing out of the oxygen removal system (4). The third steam includes steam generated by heat exchange with the outflow gas in the heat exchanger (60).

According to this configuration, the energy required for the oxygen removal system can be reduced by preheating the nitrogen-containing gas with the third steam generated by exhaust heat generated by the reaction between oxygen and hydrogen in the oxygen removal system. Thus, it is possible to improve energy efficiency by making use of exhaust heat.

(14) An ammonia derivative production method according to an aspect includes: an electrolysis step of electrolyzing water; an ammonia synthesis step of synthesizing ammonia from hydrogen produced in the electrolysis step and nitrogen; a carbon dioxide generation step of producing carbon dioxide; and an ammonia derivative synthesis step of synthesizing an ammonia derivative from ammonia synthesized in the ammonia synthesis step and carbon dioxide produced in the carbon dioxide generation step. Oxygen produced in the electrolysis step is consumed to produce carbon dioxide in the carbon dioxide generation step.

According to the ammonia derivative production method of the present disclosure, since oxygen produced by the electrolyzer is consumed to produce carbon dioxide by the carbon dioxide generation system, the production cost of ammonia derivative can be reduced.

Reference Signs List

| | |
|---|---|
| 1 | Ammonia derivative production plant |
| 2 | Nitrogen separation system |
| 4 | Oxygen removal system |
| 10 | Electrolyzer |
| 14 | Water preheater |
| 15 | Oxygen compressor |
| 17 | Oxygen vessel (Oxygen storage unit) |
| 20 | Ammonia synthesis system |
| 21 | Ammonia synthesizing gas compressor |
| 30 | Carbon dioxide generation system |
| 38 | Carbon dioxide vessel (Carbon dioxide storage unit) |
| 40 | Ammonia derivative synthesis system |
| 50 | Steam turbine |
| 60 | Heat exchanger |
| 70 | Nitrogen preheater |

1. An ammonia derivative production plant, comprising:
an electrolyzer for electrolyzing water;
an ammonia synthesis system for synthesizing ammonia from hydrogen produced by the electrolyzer and nitrogen;
a carbon dioxide generation system for producing carbon dioxide;
an ammonia derivative synthesis system for synthesizing an ammonia derivative from ammonia synthesized by the ammonia synthesis system and carbon dioxide produced by the carbon dioxide generation system;
an oxygen storage unit for storing oxygen produced by the electrolyzer; and
a carbon dioxide storage unit for storing carbon dioxide produced by the carbon dioxide generation system,
wherein oxygen produced by the electrolyzer is consumed to produce carbon dioxide by the carbon dioxide generation system.

2. The ammonia derivative production plant according to claim 1, further comprising:
a nitrogen separation system for separating nitrogen from air; and
an oxygen removal system for reacting oxygen that remains in a nitrogen-containing gas containing nitrogen separated by the nitrogen separation system with hydrogen produced by the electrolyzer,
wherein, in the ammonia synthesis system, ammonia is synthesized from an outflow gas flowing out of the oxygen removal system.

3. The ammonia derivative production plant according to claim 2,
wherein the ammonia derivative production plant is configured to use water produced by the reaction between oxygen and hydrogen in the oxygen removal system as part of water electrolyzed by the electrolyzer.

4. The ammonia derivative production plant according to claim 1, further comprising a water preheater for preheating water to be supplied to the electrolyzer,
wherein the water preheater is configured to preheat water by exhaust heat generated by the synthesis of ammonia in the ammonia synthesis system.

5. The ammonia derivative production plant according to claim 2, further comprising a water preheater for preheating water to be supplied to the electrolyzer,
wherein the water preheater is configured to preheat water by exhaust heat generated by the reaction between oxygen and hydrogen in the oxygen removal system.

6. (canceled)

7. The ammonia derivative production plant according to claim 1,
wherein the carbon dioxide generation system includes a boiler for generating a first steam by combusting a fuel,
wherein the ammonia derivative production plant further comprises a steam turbine, and
wherein a driving steam for driving the steam turbine includes:
the first steam; and
a second steam generated by exhaust heat generated by the synthesis of ammonia in the ammonia synthesis system.

8. The ammonia derivative production plant according to claim 1,
wherein the carbon dioxide generation system includes a boiler for generating a first steam by combusting a fuel,
wherein the ammonia derivative production plant further comprises:
a steam turbine;
a nitrogen separation system for separating nitrogen from air; and
an oxygen removal system for reacting oxygen that remains in a nitrogen-containing gas containing nitrogen separated by the nitrogen separation system with hydrogen produced by the electrolyzer, and
wherein a driving steam for driving the steam turbine includes:
the first steam; and
a third steam generated by exhaust heat generated by the reaction between oxygen and hydrogen in the oxygen removal system.

9. The ammonia derivative production plant according to claim 8, further comprising a heat exchanger for recovering heat from an outflow gas flowing out of the oxygen removal system,
wherein the third steam includes steam generated by heat exchange with the outflow gas in the heat exchanger.

10. The ammonia derivative production plant according to claim 7, further comprising:
an oxygen compressor for supplying oxygen produced by the electrolyzer to the carbon dioxide generation system; and
an ammonia synthesizing gas compressor for supplying nitrogen and hydrogen to the ammonia synthesis system,
wherein the oxygen compressor and the ammonia synthesizing gas compressor are driven by electric power generated by the steam turbine.

11. The ammonia derivative production plant according to claim 1, further comprising:
a nitrogen separation system for separating nitrogen from air;
an oxygen removal system for reacting oxygen that remains in a nitrogen-containing gas containing nitrogen separated by the nitrogen separation system with hydrogen produced by the electrolyzer; and
a nitrogen preheater for preheating the nitrogen-containing gas before flowing into the oxygen removal system,
wherein the nitrogen-containing gas exchanges heat in the nitrogen preheater with a second steam generated by exhaust heat generated by the synthesis of ammonia in the ammonia synthesis system.

12. The ammonia derivative production plant according to claim 1, further comprising:
a nitrogen separation system for separating nitrogen from air;
an oxygen removal system for reacting oxygen that remains in a nitrogen-containing gas containing nitrogen separated by the nitrogen separation system with hydrogen produced by the electrolyzer; and
a nitrogen preheater for preheating the nitrogen-containing gas before flowing into the oxygen removal system,
wherein the nitrogen-containing gas exchanges heat in the nitrogen preheater with a third steam generated by exhaust heat generated by the reaction between oxygen and hydrogen in the oxygen removal system.

13. The ammonia derivative production plant according to claim 12, further comprising a heat exchanger for recovering heat from an outflow gas flowing out of the oxygen removal system,
wherein the third steam includes steam generated by heat exchange with the outflow gas in the heat exchanger.

14. An ammonia derivative production method, comprising:
an electrolysis step of electrolyzing water;
an ammonia synthesis step of synthesizing ammonia from hydrogen produced in the electrolysis step and nitrogen;
a carbon dioxide generation step of producing carbon dioxide; and
an ammonia derivative synthesis step of synthesizing an ammonia derivative from ammonia synthesized in the ammonia synthesis step and carbon dioxide produced in the carbon dioxide generation step,
wherein oxygen produced in the electrolysis step is consumed to produce carbon dioxide in the carbon dioxide generation step.
